(19) United States
(12) Patent Application Publication
(10) Pub. No.: US 2012/0322967 A1
(43) Pub. Date: Dec. 20, 2012

(54) FIXING MEMBER, FIXING DEVICE, AND IMAGE FORMING APPARATUS

(76) Inventors: Tsuneaki KONDOH, Kanagawa (JP); Junichiro Natori, Kanagawa (JP); Tomoaki Sugawara, Kanagawa (JP)

(21) Appl. No.: 13/527,855

(22) Filed: Jun. 20, 2012

(30) Foreign Application Priority Data
Jun. 20, 2011 (JP) 2011-135967

(51) Int. Cl. C08G 77/24; B05D 3/06; B05D 3/10; B05D 3/04

(52) U.S. Cl. 528/42; 427/535; 427/496; 427/553

(57) ABSTRACT

To provide a fixing member, which contains an outermost layer formed of an elastic material, where the fixing member is used in a process for fixing a toner image on a recording medium by heating, and the outermost layer has peel strength of 20 N/cm² or lower.

### BACKGROUND OF THE INVENTION

1. Field of the Invention

The present invention relates to a fixing member, a fixing device containing the fixing member, and an electrophotographic image forming apparatus containing the fixing device, such as a copier, a printer, and a facsimile.

2. Description of the Related Art

Conventionally, a device employing an electrophotographic system, for example an image forming apparatus such as a photocopier, a printer, and a facsimile, typically contains a rotatable photoconductor drum. In the device, a photoconductive layer of the photoconductor drum is uniformly charged, followed by exposed to laser beams emitted from a laser scanning unit, to thereby form a latent electrostatic image on the photoconductor drum. After developing the latent electrostatic image with a toner, the developed toner image is transferred onto a transfer sheet serving as a recording material, and the resulting transfer sheet is passed through a heat fixing device, to thereby thermally fix the toner image thereon. The device is equipped with a system for performing the aforementioned operations. However, the fixing member having sufficient elasticity to attain fixing ability suitable for color image has inferior separation properties of transfer paper.

As for a fixing system, generally, a system, in which a toner deposited on a recording sheet is softened by head and at the same time pressed by passing the recording sheet between a fixing roller or fixing belt and a press roller that is in contact with the fixing roller or fixing belt with certain pressure, is employed.

Since the toner image fused on the sheet is brought into contact with a fixing member in this fixing system, a material having excellent releasing properties (e.g., a fluorine-based resin) is formed on the fixing system in a thickness of 15 μm to 30 μm. Such a fixing member has however a disadvantage that the hardness of the material thereof is high as it is a resin. The fixing member having high hardness has low correspondence to irregularities formed with paper fibers at the time when the electrostatically formed toner image is fixed by heat and pressure, and therefore a high quality image cannot be attained. Especially, in recent years, a plurality of color toners need to be melted so as to over with the fixing member for formation of color images, the hardness of the fixing member greatly affects image formation.

To solve this problem, there has been employed a method in which an elastic material (e.g., silicone rubber, and a fluororubber) is formed at a surface of a fixing member.

Use of the elastic material in the fixing member improves the aforementioned correspondence sufficient enough to attain high quality color images, but there is a problem that a transfer paper is stuck onto a surface of the fixing member because of the adhesiveness (tackiness) of the surface thereof, and hence the separation ability significantly degrades. As a countermeasure for this problem, it has been known that a silicone rubber composition is used for forming an elastic layer, and a large amount of silica powder or alumina powder is added to the silicone rubber composition. Such silicone rubber has, however, high rubber hardness, and therefore the aforementioned sufficient elasticity to provide high quality images cannot be attained. For example, moreover, Japanese Patent (JP-B) No. 3243991 discloses an invention related to a material for solving the aforementioned problem by reducing crosslink density to lower hardness of rubber. In this case, the adhesiveness (tackiness) of the surface increases due to reduced crosslink density, and therefore sufficient releasing ability cannot be secured.

Japanese Patent Application Laid-Open (JP-A) No. 2007-114249 discloses that a fixing member contains a bearing member, at least one layer of an elastic material layer provided on the bearing member, and an outermost layer containing fluorocarbon siloxane rubber, and that the extracted amount of the polydimethyl siloxane component, which is Soxhlet extracted from the elastic material constituting the elastic material layer is adjusted to 0.4% by mass or lower to improve peeling properties.

JP-A No. 2009-198788 discloses that in order to improve releasing properties, a surface of a fixing member to be in contact with a toner image is formed of rubber, which is at least one selected from the group consisting of silicone rubber, fluorocarbonsiloxane rubber, and fluorosilicone rubber, and has irregularities formed therein.

However, any of the aforementioned fixing members does not have sufficient separation properties of transfer paper.

The present invention aims to solve the aforementioned various problems in the art, and to achieve the following object. An object of the present invention is to provide a fixing member, which can improve releasability of a transfer sheet by reducing adhesiveness (tackiness) of an outermost surface thereof, with maintaining sufficient elasticity to attain high image quality corresponding to color image formation, can reduce jamming caused by wrapping with the transfer sheet, and can realize stable fixing over a long period.

### SUMMARY OF THE INVENTION

As a result of the researches diligently conducted by the present inventors to solve the aforementioned problems, the present inventors have attained insights that the aforementioned problems can be solved by forming an outermost layer of a fixing member with an elastic material, and designing the outermost layer to have peal stress of 20 N/cm² or lower, to thereby accomplish the present invention.

The present invention has been accomplished based on the insights of the present inventors, and means for solving the aforementioned problems are as follows.

A fixing member, containing:

an outermost layer formed of an elastic material,

wherein the fixing member is used in a process for fixing a toner image on a recording medium by heating, and

wherein the outermost layer has peel strength of 20 N/cm² or lower.

The present invention can solve the aforementioned various problems in the art, achieve the aforementioned object, and provide a fixing member, which can improve releasability of a transfer sheet by reducing adhesiveness (tackiness) of an outermost surface thereof, with maintaining sufficient elasticity to attain high image quality corresponding to color image formation, can reduce jamming caused by wrapping with the transfer sheet, and can realize stable fixing over a long period.

### BRIEF DESCRIPTION OF THE DRAWINGS

FIG. 1 is a schematic cross-sectional view illustrating one example of the structure of the fixing member.

FIG. 2 is a schematic cross-sectional view illustrating one example of the fixing device of a belt system.

FIG. 3 is a schematic cross-sectional view illustrating one example of the image forming apparatus.

FIG. 4 is a graph depicting a relationship between the peal strength and the pealing duration.

### DETAILED DESCRIPTION OF THE INVENTION

### Fixing Member

The fixing member of the present invention contains an outermost layer formed of an elastic material, where wherein the fixing member is used in a process for fixing a toner image on a recording medium by heating. The fixing member preferably further contains a base, and may further contain other members, if necessary.

The outermost layer has peal stress of 20 N/cm² or lower.

### <Outermost Layer>

The outermost layer is formed of an elastic material.

The elastic material is appropriately selected depending on the intended purpose without any limitation, but it is preferably rubber, more preferably heat resistance rubber.

The rubber is appropriately selected depending on the intended purpose without any limitation, and examples thereof include natural rubber, SBR, butyl rubber, chloroprene rubber, nitrile rubber, acryl rubber, urethane rubber, silicone rubber, fluorosilicone rubber, fluororubber, liquid fluoroelastomer. These may be used independently, or in combination. Among them, silicone rubber, fluorosilicone rubber, fluororubber, fluorocarbon siloxane rubber, and liquid fluoroelastomer are preferable in view of heat resistance. In view of heat resistance and wetting ability of a releasing agent, rubber having siloxane bonds in a backbone of a molecule thereof is preferable, silicone rubber and fluorosilicone rubber are more preferable, and fluorosilicone rubber is particularly preferable.

The silicone rubber includes, for example, polydimethyl silicone rubber containing a constitutional unit represented by the following general formula.

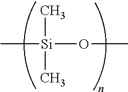

In the general formula above, n is an integer of 1 or greater.

The polydimethyl silicone rubber may be appropriately synthesized for use, or may be appropriately selected from commercial products. Examples of the commercial product thereof include KE1950-30 (manufactured by Shin-Etsu Chemical Co., Ltd.), and DY35-2083 (manufactured by Dow Corning Toray Co., Ltd.).

The fluorosilicone rubber includes, for example, rubber containing a constitutional unit represented by the following general formula.

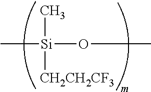

In the general formula above, m is an integer of 1 or greater.

The fluorosilicone rubber may be appropriately synthesized for use, or may be appropriately selected from commercial products. Examples of the commercial product thereof include X36-420U (manufactured by Shin-Etsu Chemical Co., Ltd.), FSE7540, FSL7641 (manufactured by Momentive Performance Materials Inc.), and SE-1541-U (manufactured by Dow Corning Toray Co., Ltd.).

The weight average molecular weight of the silicone rubber having siloxane bonds in the backbone of the molecule thereof is appropriately selected depending on the intended purpose without any limitation, but it is preferably 5,000 to 100,000. The weight average molecular weight can be measured, for example, by gel permeation chromatography (GPC).

The outermost layer may optionally contain additives, such as a releasing agent for providing releasing properties (e.g. low molecular weight silicone oil), fillers (e.g., silica), an antioxidant, a colorant, and a vulcanizing agent.

A surface of the outermost layer may be subjected to a modification treatment for the purpose of improving its functions, such as toner releasing properties, and abrasion resistance.

### <Base>

The base is appropriately selected from those known in the art, without any restriction on its shape, structure, thickness, material, and size.

The shape of the base is appropriately selected depending on the intended purpose without any limitation, and examples thereof include a plate shape, a belt shape, and a cylindrical shape.

The structure of the base is appropriately selected depending on the intended purpose without any limitation, and the base may have a single layer structure, or a laminate structure.

The material of the base is appropriately selected depending on the intended purpose without any limitation, but it is preferably a material having heat resistance. Examples thereof include a resin and a metal.

The resin is appropriately selected depending on the intended purpose without any limitation, and examples thereof include polyimide, polyamide imide, polyether ether ketone (PEEK), polyether sulfone (PES), polyphenylene sulfide (PPS), and a fluororesin. Also, a resin in which magnetic conductive particles are dispersed can be used as the resin. In this case, the magnetic conductive particles are added to the resin material preferably in an amount ranging from 20% by mass to 90% by mass. Specifically, the magnetic conductive particles are dispersed in the resin material in the state of varnish by means of a dispersing device, such as a roll mill, a sand mill, and a centrifugal deaerator. The resultant is appropriately adjusted with a solvent to give an appropriate viscosity, and then molded in a metal mold to have a predetermined layer thickness.

The metal is appropriately selected depending on the intended purpose without any limitation, and examples thereof include nickel, iron, chromium, and alloys thereof. The metal may generate heat by itself.

Among them, the base is particularly preferably a base having a cylindrical hollow structure, and equipped with a heating medium that is provided inside the hollow structure, in view of heating efficiency.

Examples of the heating medium include a halogen heater, a ceramic heater, and a metal roller capable of induction heating.

A thickness of the base is appropriately selected depending on the intended purpose without any limitation, but it is preferably 30 μm to 500 μm in view of its thermal capacity and strength, more preferably 50 μm to 150 μm.

In the case where the material of the base is a metal, a thickness of the base is preferably 100 μm or less, in view of bent when the fixing member is in the form of a belt.

In the case where the base is formed of the metal material, a predetermined Curie point can be attained by adjusting an amount of each material to be added and processing conditions. By forming a heating layer with the magnetic electrical conductive material having the Curie point at the temperature adjacent to the fixing temperature of the fixing belt, the heating layer can be heated by electromagnetic induction without over heated.

### <Other Members>

Other members are appropriately selected depending on the intended purpose without any limitation, and examples thereof include a primer layer, and an intermediate layer.

A shape of the fixing member of the present invention is appropriately selected depending on the intended purpose without any limitation, provided that the fixing member has the aforementioned characteristics. Examples of the shape thereof include a roller shape, a belt shape, and a sheet shape.

The peal stress of the outermost layer of the fixing member is 20 N/cm² or lower, but it is more preferably lower than 14 N/cm², even more preferably 7 N/cm² or lower. In the present specification, the peal stress is a value measured by the following tackiness evaluation test.

### [Tackiness Evaluation Test]

Under the following measuring conditions (tackiness evaluation conditions), as a measuring device, a tacking tester of Rhesca Corporation is used, but the measuring device is not limited to the aforementioned tacking tester, and any device can be used as long as the equivalent measurement result can be attained thereby.

TABLE 1

| | |
|---|---|
| Measuring device | Tacking tester, manufactured by Rhesca |
| | Corporation |
| Probe measuring | Diameter of 3 |
| area | |
| Probe | SUS |
| Contact speed | 120 mm/min |
| Withdrawal speed | 600 mm/min |
| Contact duration | 1 sec |
| Temperature of probe | 25° C. ± 2° C. |
| Compression stress | About 10 N/cm² |
| Peel stress | The peel stress (N/cm²) per unit area, which |
| | is calculated from the peak of peel strength |
| | depicted in the graph in which the peel strength is |
| | plotted on the ordinate axis, and duration for |
| | peeling is plotted on the transverse axis. |

The universal hardness of the outermost layer of the fixing member is appropriately selected depending on the intended purpose without any limitation, but it is preferably lower than 0.5 N/mm². In the present specification, “universal hardness” is hardness as measured in accordance with DIN 50359. Specifically, the universal hardness can be determined by the following measuring method.

### [Universal Hardness Evaluation Test]

Under the following measuring conditions (universal hardness evaluation conditions), as a measuring device, Win-HUD of Fischer Instruments K.K. is used, but the measuring device is not limited to the aforementioned device, and any device can be used as long as the equivalent measurement result can be attained thereby.

TABLE 2

| | |
|---|---|
| Device | Win-HUD, manufactured by Fischer Instruments |
| | K.K. |
| Indenter | Quadrangular pyramid diamond having a plane |
| | angle of 136° |
| Initial load | 0.02 mN |
| Maximum load | 400 mN |
| Duration for increasing | 10 sec |
| load | |
| Indentation depth | 5 μm |
| Measuring temperature | 25° C. ± 2° C. |

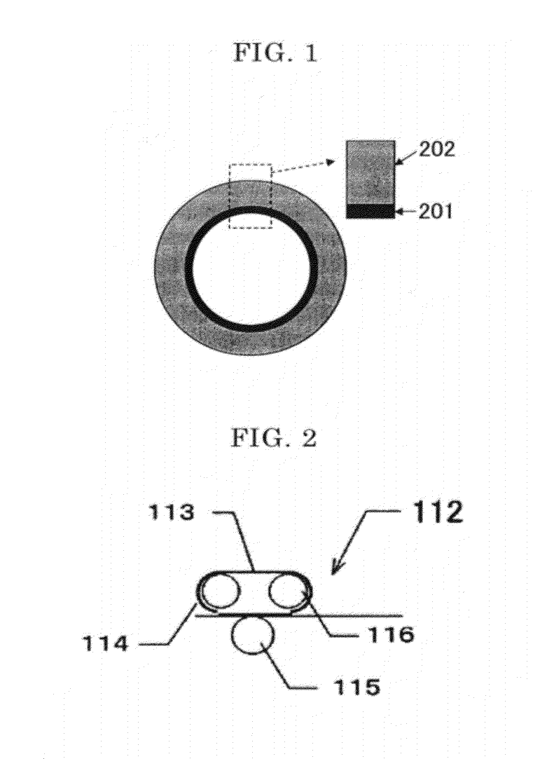

FIG. 1 is a schematic cross-sectional view illustrating one example of the fixing member of the present invention, and the fixing member contains a base 201, and an elastic layer 202.

### (Production for Producing Fixing Member)

The method for producing a fixing member of the present invention contains at least an outermost layer forming step, and a modification treatment step, and may further contain other steps, if necessary.

### <Outermost Layer Forming Step>

The outermost layer forming step is forming an outermost layer containing an elastic material on a base.

The method for forming the outermost layer is appropriately selected depending on the intended purpose without any limitation, but it is preferably a method including applying a primer onto a surface of the base, fixing the primer-treated base, applying a composition containing the elastic material to the primer-treated base, heating (primary curing), and performing secondary curing (heating agent) to thereby form an outermost layer.

The composition is appropriately selected depending on the intended purpose without any limitation, as long as it contains the elastic material. The composition may be an elastic material itself.

The method for applying the composition is appropriately selected depending on the intended purpose without any limitation, and examples thereof include blade coating, roller coating, and die coating.

### <Modification Treatment Step>

The modification treatment step is modifying the outermost layer by any of a plasma treatment, electron beam crosslinking treatment, or UV ozone treatment.

### —Plasma Treatment—

The plasma treatment can be performed, for example, by a plasma generator. As for the plasma generator, there are a horizontal plate-type device, capacitive coupling-type device, and inductive coupling-type device. Moreover, the plasma treatment can be performed by corona discharge, or by means of an atmospheric pressure plasma device. The plasma treatment is preferably a vacuum plasma treatment in view of durability of the resulting outermost layer.

The reaction pressure for the plasma treatment is appropriately selected depending on the intended purpose without any limitation, but it is preferably 0.05 Pa to 100 Pa, more preferably 1 Pa to 20 Pa.

The reaction gas used for the plasma treatment is appropriately selected depending on the intended purpose without any limitation, but inert gas, rare gas, and gas such as oxygen are effectively used. Among then, argon is particularly preferable in view of its long lasting effect.

The irradiated electric energy for the plasma treatment is appropriately selected depending on the intended purpose without any limitation, but it is preferably the irradiated electric energy defined by (output×irradiation duration) of 5 Wh to 200 Wh, more preferably 5 Wh to 50 Wh.

### —Electron Beam Crosslinking Treatment—

The electron beam crosslinking can be performed, for example, by an electron beam irradiation device (e.g., line emission type EB-ENGINE, manufactured by Hamamatsu Photonics K.K.).

The irradiation dose for the electron beam crosslinking treatment is appropriately selected depending on the intended purpose without any limitation, but it is preferably 0.01 MGy to 50 MGy, more preferably 0.1 MGy to 20 MGy.

The reaction gas used for the electron beam crosslinking treatment is appropriately selected depending on the intended purpose without any limitation, and examples thereof include nitrogen gas, argon gas, and xenon gas. Among them, nitrogen gas is preferable.

The oxygen concentration for the electron beam crosslinking treatment is appropriately selected depending on the intended purpose without any limitation, but it is preferably 0.01 ppm to 5,000 ppm, more preferably 10 ppm to 2,000 ppm.

### —UV Ozone Treatment—

The UV ozone treatment can be performed, for example, by means of a UV irradiating device (e.g., UVC-02516S1AB01 (lamp fitting: UVH—0252C-2200, and lamp: UVL-4001M3-N1) of USHIO INC., and VUV-050/A-5S of Orc Manufacturing Co., Ltd.).

The UV illuminance for the UV ozone treatment is appropriately selected depending on the intended purpose without any limitation, but it is preferably 0.1 mW/cm² to 500 mW/cm², more preferably 1 mW/cm² to 200 mW/cm².

The duration for the UV ozone treatment is appropriately selected depending on the intended purpose without any limitation, but it is preferably 1 minute to 120 minutes, more preferably 5 minutes to 60 minutes.

### <Other Steps>

Other steps are appropriately selected depending on the intended purpose without any limitation, and examples thereof include a step for appropriately modifying the outermost layer with various material.

Examples of the modification include: a method for modifying the outermost layer with a coupling agent, or various monomers; and a method for introducing a photosensitive functional group, or a hydrophobic or hydrophilic functional group to the outermost layer. As a result of these modifications, functions such as toner releasing properties, or abrasion resistance can be provided. Among them, the method for treating with the coupling agent is preferable.

For example, the coupling agent is preferably a fluoropolymer, more preferably an amorphous resin containing at least one functional group selected from a hydroxyl group, a silanol group, a carboxyl group, and a group capable of inducing hydrolysis. It is particularly preferred that the amorphous resin and the elastic material of the outermost layer be bonded via oxygen atoms.

Examples of the amorphous resin include a resin having perfluoroalkyl polyether in its principal chain.

Examples of the group capable of inducing hydrolysis include; an alkoxy group such as a methoxy group, and an ethoxy group; and an alkoxy silane group such as a methoxy silane group, and an ethoxy silane group. By introducing such functional groups, releasing properties to the melted toner can be provided.

The coupling agent is preferably used by dissolving in metal alkoxide or a solution containing metal alkoxide.

The metal alkoxide includes, for example, a silicone alkoxide-based monomer represented by the general formula (1), partially hydrolyzed polycondensate thereof having a polymerization degree of about 2 to about 10, a mixture thereof, and/or a solution containing the foregoing monomer or compounds and an organic solvent.

R₁₍₄₋ₙ₎M(OR₂)ₙ General Formula (1)

In the general formula (1), R₁ and R₂ are each independently a C1-C10 linear or branched chain alkyl group, an alkyl polyether chain, or an aryl group or derivatives thereof; M is a metal atom; and n is an integer of 2 to 4.

“M” in the general formula (1) is preferably Si, Ti, Sn, Al, or Zr, and these coupling agents may be used independently or in a mixture. Among them, “M” is particularly preferably Si.

“R₁” in the general formula (1) may be a fluoroalkyl group, or fluoroalkylacrylate or perfluoropolyether to which the fluoroalkyl group is further bonded via an oxygen atom. In view of flexibility and durability, a perfluoropolyether group is particularly preferable.

Specific examples of the compound represented by the general formula (1) include dimethyl dimethoxy silane, diethyl diethoxy silane, diethyl dimethoxy silane, diethyl diethoxy silane, diphenyl dimethoxy silane, diphenyl diethoxy silane, methyl trimethoxy silane, methyl triethoxy silane, tetramethoxy silane, tetraethoxy silane, and tetrapropoxy silane. In view of the durability, tetraethoxy silane is particularly preferable.

The compound represented by the general formula (1) includes: vinyl silanes such as vinyl tris(β-methoxyethoxy)silane, vinyl triethoxy silane, and vinyl trimethoxy silane; acryl silanes such as γ-methacryloxypropyl trimethoxy silane; epoxy silanes, such as β-(3,4-epoxycyclohexyl)ethyl trimethoxysilane, γ-glycidoxypropyl trimethoxysilane, and γ-glycidoxypropylmethyl diethoxysilane; and amino silanes such as N-β(aminoethyl)-γ-aminopropyl trimethoxysilane, N-β-(aminoethyl)-γ-aminopropylmethyl dimethoxysilane, γ-aminopropyl triethoxysilane, and N-phenyl-γ-aminopropyl trimethoxysilane.

The treatment with a surface treating agent, such as the aforementioned coupling agent can be performed by, after performing the surface modification treatment (e.g., a plasma treatment, electron beam crosslinking, and UV ozone treatment) onto the elastic material, impregnating a surface of the elastic material with the surface treating agent by coating or dipping.

### (Fixing Device)

The fixing device of the present invention contains the fixing member of the present invention, and may further contain other members, if necessary.

The fixing member includes, for example, a fixing roller, and a fixing belt.

FIG. 2 is a schematic cross-sectional view illustrating one example of a fixing device 112 of a belt system, which contains the fixing member of the present invention.

In FIG. 2, the reference numerals 113, 114, 115, and 116 denote a fixing belt, a fixing roller, a pressure roller, and a heating roller, respectively.

Four color toners, including magenta, cyan, yellow, and black, are used in a full-color photocopier or laser printer. During fixing of a color image, these color toners need to be mixed in the melted state. Accordingly, the toner is designed to have a low melting point so that it is easily melted, and the plurality of the color toners are uniformly mixed in the melted state on a surface of the fixing belt 113 in the manner that the color toners are covered with the fixing belt 113. (The fixing roller and the fixing belt may be collectively referred as a “fixing member” hereinafter.)

As illustrated in FIG. 2, the fixing belt 113 serving as a heat generating member is suspended around and supported by the fixing roller 114 and the heating roller 116.

### (Image Forming Apparatus)

The image forming apparatus of the present invention contains at least a fixing unit, preferably further contains a latent electrostatic image bearing member (may also referred as an “electrophotographic photoconductor,” “photoconductor,” and “image bearing member” hereinafter), a latent electrostatic image forming unit, a developing unit, and a transferring unit, and may further contain appropriately selected other units, such as a diselectrification unit, a recycling unit, and a controlling unit, if necessary. The fixing unit is the fixing device of the present invention.

### <Latent Electrostatic Image Bearing Member>

The latent electrostatic image bearing member (may also referred as an “electrophotographic photoconductor,” “photoconductor,” and “image bearing member” hereinafter) is appropriately selected from those known in the art without any restriction on its material, shape, structure, and size. As for the shape thereof, a drum shape is preferable. Examples of the material thereof include: inorganic photoconductors such as amorphous silicon, and selenium; and organic photoconductors such as polysilane, and phthalopolymethine. Among them, amorphous silicon is preferable in view of long service life.

### <Latent Electrostatic Image Forming Unit>

The latent electrostatic image forming unit is a unit configured to form a latent electrostatic image on the latent electrostatic image bearing member.

The formation of the latent electrostatic image can be performed, for example, by uniformly charging a surface of the latent electrostatic image bearing member, followed by exposing the charged surface of the latent electrostatic image bearing member to light imagewise, and can be performed by the latent electrostatic image forming unit. The latent electrostatic image forming unit is, for example, equipped with at least a charger configured to uniformly charge a surface of the latent electrostatic image bearing member, and an exposure unit configured to expose the charged surface of the latent electrostatic image bearing member to light imagewise.

The charging can be performed, for example, by applying voltage to the surface of the latent electrostatic image bearing member using the charger.

The charger is appropriately selected depending on the intended purpose without any limitation, and examples thereof include: conventional contact chargers known in the art equipped with a conductive or semiconductive roller, brush, film, rubber blade, or the like; and conventional non-contact chargers using corona discharge such as corotron and scorotron.

The exposing can be performed, for example, by exposing a surface of the latent electrostatic image bearing member to light imagewise using the exposing unit.

The exposing unit is appropriately selected depending on the intended purpose without any limitation, provided that it can expose the charged surface of the latent electrostatic image bearing member by the charger to light imagewise to write an image be formed. Examples thereof include various exposing units such as a reproduction optical exposing device, a rod-lens array exposing device, a laser optical exposure device, and a liquid crystal shutter optical device.

Note that, in the present invention, a back-side light exposure, in which the back side of the latent electrostatic image bearing member is exposed to light imagewise, may be employed.

### <Developing Unit>

The developing unit is a unit configured to develop the latent electrostatic image with a toner and/or developer, to thereby form a visible image.

The formation of the visible image can be performed, for example, by developing the latent electrostatic image with the toner and/or developer, and can be performed by the developing unit.

The developing unit is appropriately selected from conventional developing units known in the art without any limitation, provided that it can carry out developing using the toner and/or developer. Preferable examples thereof include a developing unit containing at least a developing instrument housing the toner and/or developer therein and capable of directly or non-directly providing the toner and/or developer to the latent electrostatic image.

The developing instrument may be of a dry developing system, or of a wet developing system. The developer instrument moreover may be a monocolor developing instrument, or a multicolor developing instrument. Preferable examples thereof include a developing instrument containing a stirrer configured to stir the toner and/or developer to be charged by friction, and a rotatable magnet roller.

Inside the developing instrument, for example, the toner and the carrier are mixed and stirred, and the toner is charged by the frictions from the stirring. The charged toner is held on a surface of the rotating magnet roller in the form of a brush, to thereby form a magnetic brush. Since the magnet roller is disposed adjacent to the latent electrostatic image bearing member (photoconductor), part of the toner constituting the magnetic brush formed on the surface of the magnet roller is moved onto the surface of the latent electrostatic image bearing member (photoconductor) by electric attraction force. As a result, the latent electrostatic image is developer with the toner, to thereby form a visible image formed of the toner on the surface of the latent electrostatic image bearing member (photoconductor).

The toner is appropriately selected from conventional toners known in the art without any limitation.

### <Transferring Unit>

The transferring unit is a unit configured to transfer the visible image to a recording medium, but it preferably has an embodiment where an intermediate transfer member is used, and the visible image is primary transferred to the intermediate transfer member, followed by secondary transferring the visible image to the recording medium. The more preferable embodiment of the transferring unit is that as the toner, two or more colors of the toner, or full-color toner is used, and the transferring unit contains a primary transferring unit configured to transfer a visible image to an intermediate transfer member to thereby form a composite transfer image, and a secondary transferring unit configured to transfer the composite transfer image to a recording medium.

The intermediate transfer member is appropriately selected from transfer members known in the art without any limitation, and preferable examples thereof include a transfer belt.

The transferring unit (the primary transferring unit, the secondary transferring unit) preferably contains at least a transferring equipment configured to charge the visible image formed on the latent electrostatic image bearing member (photoconductor) to thereby make the visible image detach and move to the side of the recording medium. The number of the transferring units contained in the image forming apparatus may be one, or two or more.

Examples of the transferring equipment include a corona transferrer using corona discharge, a transfer belt, a transfer roller, a pressure transfer roller, and an adhesion transfer equipment.

The recording medium is appropriately selected depending on the intended purpose without any limitation.

An amount of calcium carbonate in the recording medium is typically appropriately 5% by mass. In the case where a recording medium having a high amount of the calcium carbonate, 15% by mass, the fixing member of the present invention excels its durability because calcium carbonate is not stuck in recess portions of the surface layer of the fixing member, whereby the toner is not gradually deposited thereon using the stacked calcium carbonate as a core.

### <Fixing Unit>

The fixing unit is a unit configured to fix the transferred visible image into a recording medium by means of the fixing device of the present invention. The fixing may be performed every time when a toner image of each color is transferred to the recording medium, or may be performed once in the state where toner images of all the colors are laminated.

### <Other Units>

### —Diselectrification Unit—

The diselectrification unit is a unit configured to apply diselectrification bias to the latent electrostatic image bearing member to thereby diselectrify the latent electrostatic image bearing member.

The diselectrification unit is appropriately selected from conventional diselectrification units known in the art without any limitation, provided that it is capable of applying diselectrification bias to the latent electrostatic image bearing member. Preferable examples thereof include a diselectrification lamp.

### —Cleaning Unit—

The cleaning unit is a unit configured to remove the toner remained on the latent electrostatic image bearing member.

The cleaning unit is appropriately selected from conventional cleaners known in the art without any limitation, provided that it can remove the toner remained on the latent electrostatic image bearing member. Preferable examples thereof include a magnetic brush cleaner, an electrostatic brush cleaner, a magnetic roller cleaner, a blade cleaner, a brush cleaner, and a web cleaner.

### —Recycling Unit—

The recycling unit is a unit configured to recycle the toner, which has been removed by the cleaning unit, to the developing unit.

The recycling unit is not particularly limited, and examples thereof include conventional conveying units known in the art.

### —Controlling Unit—

The controlling unit is a unit configured to control each unit. The controlling unit is appropriately selected depending on the intended purpose without any limitation, provided that it can control the operation of each unit. Examples thereof include devices such as a sequencer, and a computer.

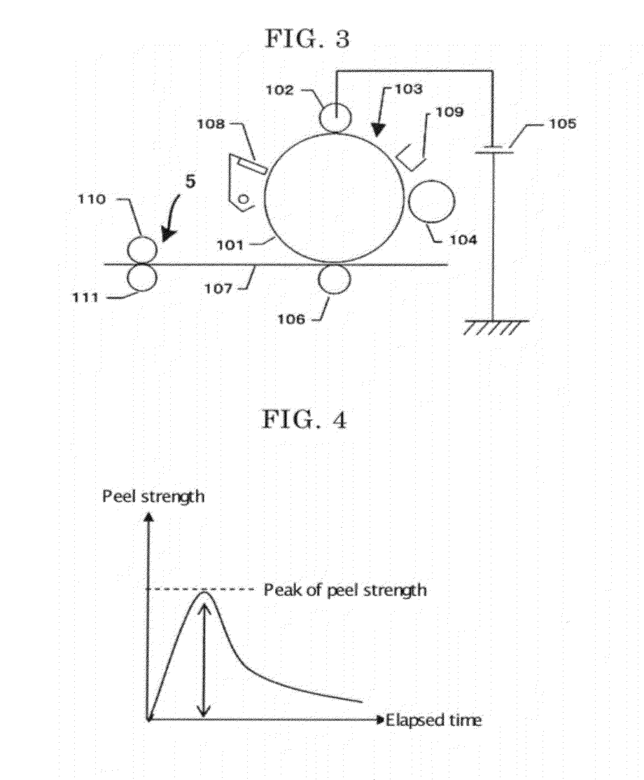

FIG. 3 conceptually depicting the structure of a photoconductor, its image forming system, and a fixing device in the image forming apparatus.

The image formation process in the electrophotographic image forming apparatus includes: uniformly charging a photoconductive layer of a rotating photoconductor drum 101 using a charging roller 102; exposing the photoconductive layer to laser beams 103 emitted from a laser scanning unit that is not illustrated in the drawing to thereby form a latent electrostatic image on the photoconductor drum 101; developing the latent electrostatic image with a toner to form a toner image; transferring the toner image onto a recording medium 107; and passing the recording medium 107 through a fixing device 5 to heat and press the toner image to thereby fix the toner image on the recording medium 107. Note that, in FIG. 3, 104 denotes a developing roller, 105 denotes a power pack (power source), 106 denotes a transfer roller, 108 denotes a cleaning device, and 109 denotes a surface static charge gage. In the fixing device 5, for example, a heat fixing roller 110, which contains a core rod that is an aluminum hollow cylinder or the like, and an anti-adhesion layer formed that is a fluororesin layer or the like provided on the circumferential surface of the core rod is used, and the anti-adhesion layer is provided for preventing the toner from adhering. The heat fixing roller 110 contains a heater (e.g. a halogen lamp) provided in the hollow part of the core rod along the center line of rotation, and the heat fixing roller 110 is heated from inside by radiant heat of the heater.

Moreover, a pressure roller 111 is provided parallel to the heat fixing roller 110 so as to be in contact with the heat fixing roller 110 with pressure. By passing the recording medium 107 through the nip between the pressure roller 111 and the heat fixing roller 110, the toner deposited on the recording medium 107 is softened by the heat of the heat fixing roller 110, and at the same time, is pressed by nipped between the pressure roller 111 and the heat fixing roller 110, to thereby fix the toner image onto the recording medium 107.

### EXAMPLES

Examples of the present invention will be explained hereinafter, but these Examples shall not be construed as to limit the scope of the present invention.

### Example 1

A primer layer for silicone (Primer C, manufactured by Shin-Etsu Chemical Co., Ltd.) was formed as a base on a cylindrical support (polyimide) having a length of 320 mm, and thickness of 50 μm, and was dried. Thereafter, fluorosilicone rubber (X36-420U, manufactured by Shin-Etsu Chemical Co., Ltd.) was formed in the thickness of 200 μm on the base, and heated at 150° C. for 10 minutes.

The formed fluorosilicone rubber was subjected to a plasma treatment under the following conditions.

Derive: PR-500, manufactured by Yamato Scientific Co., Ltd.

Output: 100 W

Duration for the treatment: 4 minutes

Reaction gas: argon (99.999%)

Reaction pressure: 10 Pa

On the fluorosilicone rubber, a 0.1% by mass diluted solution prepared by diluting a filuorocarbon compound, OPTOOL DSX (manufactured by Daikin Industries, Ltd.), with perfluorohexane was applied by dip coating at the withdrawal speed of 10 mm/min, and then was left in the environment having the temperature of 60° C. and the relative humidity of 90% for 30 minutes or longer. Thereafter, the resultant was dried at 150° C. for 10 minutes to thereby prepare a fixing member.

The fixing member produced in the aforementioned manner was subjected to the measurement under the tackiness evaluation conditions specified in Table 1 to thereby determine peel stress of the outermost layer. The separation evaluation was performed on the same fixing member in the following.

### [Separation Evaluation]

First, an SUS probe was pressed against the fixing member immobilized on a stage under certain conditions, and withdrawn therefrom at the predetermined speed after the predetermined time elapsed. At the time of withdrawal, a peak value of the peel force was attained. The relationship between the duration for peeling, and the peal stress per unit area, which is obtained by dividing the value of the peak of the peel stress with the area of the probe, is depicted in FIG. 4.

The separation evaluation was performed by carrying out a running test on 30,000 sheets of paper using a photocopier (imagio MPC3000, Ricoh Company Limited) in which the produced fixing member was mounted in a fixing device, and determining the occurrence of paper jamming due to separation failure. As paper for testing, 10,000 sheets of each of Multi-paper Super White (available from Askul Co., Ltd.), Myrecycle Paper 100 (Ricoh Company Limited), and POD Gloss-Coat Paper (Oji Paper Co., Ltd.) (paper weight: 90 kg) were used, and evaluated based on the criteria presented in Table 3.

TABLE 3

| Evaluation | | |
|---|---|---|
| item | Evaluation method | Evaluation criteria |
| Peel stress | Calculating peel stress | Acceptable: 20 N/cm² or |
| | (N/cm²) under the | lower |
| | conditions specified in | Not acceptable: Higher |
| | Table 1 | than 20 N/cm² |
| Separation | Judging the occurrence | B: jamming occurred |
| evaluation | of jamming due to | A: no jamming |
| | separation failure | |
| Universal | Calculating universal | Acceptable: lower than 0.5 N/mm² |
| hardness | hardness (N/mm²) under | Not acceptable: 0.5 N/mm² |
| | the conditions specified | or higher |
| | in Table 2 | |

### Example 2

A fixing member was produced in the same manner as in Example 1, provided that instead of the fluorosilicone, silicone (DY35-2083, manufactured by Toray Industries, Inc.) was coated by blade coating in the thickness of 200 μm, heated at 150° C. for 30 minutes, and subjected to secondary cure at 200° C. for 4 hours. The produced fixing member was evaluated in the same manner as in Example 1.

### Example 3

A fixing member was produced in the same manner as in Example 1, provided that instead of the fluorocarbon compound (OPTOOL DSX), tetraethyl orthosilicate (manufactured by Wako Pure Chemical Industries, Ltd.) was applied by dip coating. The produced fixing member was evaluated in the same manner as in Example 1.

### Example 4

A fixing member was produced in the same manner as in Example 1, provided that as the plasma reaction gas, nitrogen was used instead of argon. The produced fixing member was evaluated in the same manner as in Example 1.

### Example 5

A fixing member was produced in the same manner as in Example 1, provided that as the plasma reaction gas, oxygen was used instead of argon. The produced fixing member was evaluated in the same manner as in Example 1.

### Example 6

A primer layer for silicone (Primer C, manufactured by Shin-Etsu Chemical Co., Ltd.) was applied as an primer onto a cylindrical base (polyimide) having a length of 320 mm, and thickness of 50 μm, and was dried. Thereafter, fluorosilicone rubber (X36-420U, manufactured by Shin-Etsu Chemical Co., Ltd.) was applied by blade coating in the thickness of 200 μm on the base, and heated at 150° C. for 10 minutes.

The formed fluorosilicone rubber was subjected to a plasma treatment under the following conditions, to thereby produce a fixing member.

Derive: PR-500, manufactured by Yamato Scientific Co., Ltd.

Output: 100 W

Duration for the treatment: 4 minutes

Reaction gas: argon (99.999%)

Reaction pressure: 10 Pa

The fixing member produced in the aforementioned manner was subjected to the measurement under the tackiness evaluation conditions specified in Table 1 to thereby determine peel stress of the outermost layer. The separation evaluation was performed on the same fixing member in the manner as described above.

### Example 7

A primer layer for silicone (Primer C, manufactured by Shin-Etsu Chemical Co., Ltd.) was applied as an primer onto a cylindrical base (polyimide) having a length of 320 mm, and thickness of 50 μm, and was dried. Thereafter, fluorosilicone rubber (X36-420U, manufactured by Shin-Etsu Chemical Co., Ltd.) was applied by blade coating in the thickness of 200 μm on the base, and heated at 150° C. for 10 minutes.

The formed fluorosilicone rubber was subjected to an electron beam crosslinking treatment under the following conditions, to thereby produce a fixing member.

Irradiation source: line emission type EB-ENGINE (manufactured by Hamamatsu Photonics K.K.)
Irradiation dose: 1 MGy

### Atmosphere gas: N₂

Oxygen concentration of atmosphere: 100 ppm
The fixing member produced in the aforementioned manner was subjected to the measurement under the tackiness evaluation conditions specified in Table 1 to thereby determine peel stress of the outermost layer. The separation evaluation was performed on the same fixing member in the manner as described above.

### Example 8

A primer layer for silicone (Primer C, manufactured by Shin-Etsu Chemical Co., Ltd.) was applied as an primer onto a cylindrical base (polyimide) having a length of 320 mm, and thickness of 50 μm, and was dried. Thereafter, fluorosilicone rubber (X36-420U, manufactured by Shin-Etsu Chemical Co., Ltd.) was applied by blade coating in the thickness of 200 μm on the base, and heated at 150° C. for 10 minutes.

The formed fluorosilicone rubber was subjected to a UV ozone treatment under the following conditions, to thereby produce a fixing member.

Device: VUV-050/A-5S (manufactured by Orc Manufacturing Co., Ltd.)
UV illuminance: 6.8 mW/cm²
Duration of treatment: 5 minutes

The fixing member produced in the aforementioned manner was subjected to the measurement under the tackiness evaluation conditions specified in Table 1 to thereby determine peel stress of the outermost layer. The separation evaluation was performed on the same fixing member in the manner as described above.

### Example 9

Butyl rubber (BR51, JSR Corporation) was applied in a thickness of 200 μm onto a cylindrical base (polyimide) having a length of 320 mm, and thickness of 50 μm by blade coating, and was dried. The resultant was heated at 150° C. for 15 minutes. The resulting layer was subjected to a plasma treatment under the same conditions as in Example 6, to thereby produce a fixing member. The produced fixing member was evaluated in the same manner as in Example 1.

### Example 10

### Ethylene propylene rubber (EP11, manufactured by JSR Corporation) was applied in a thickness of 200 μm onto a cylindrical base (polyimide) having a length of 320 mm, and thickness of 50 μm by blade coating, and was dried. The resultant was heated at 150° C. for 15 minutes. The resulting layer was subjected to a plasma treatment under the same conditions as in Example 6, to thereby produce a fixing member. The produced fixing member was evaluated in the same manner as in Example 1.

### Comparative Example 1

A primer layer for silicone (Primer C, manufactured by Shin-Etsu Chemical Co., Ltd.) was applied as an primer onto a cylindrical base (polyimide) having a length of 320 mm, and thickness of 50 μm, and was dried. Thereafter, fluorosilicone rubber (X36-420U, manufactured by Shin-Etsu Chemical Co., Ltd.) was applied by blade coating in the thickness of 200 μm on the base, and heated at 150° C. for 10 minutes, to thereby produce a fixing member. The produced fixing member was evaluated in the same manner as in Example 1.

### Comparative Example 2

A fixing member was produced in the same manner as in Comparative Example 1, provided that instead of the fluorosilicone, silicone (DY35-2083, manufactured by Toray Industries, Inc.) was coated in the thickness of 200 μm by blade coating, heated at 150° C. for 30 minutes, and subjected to secondary cure at 200° C. for 4 hours. The produced fixing member was evaluated in the same manner as in Example 1.

Table 4 depicts the evaluation results of Examples and Comparative Examples.

TABLE 4

| | Peel stress | Separation | |
|---|---|---|---|
| | (N/cm²) | evaluation | Universal hardness |
| Ex. 1 | 5 | A | 0.4 |
| Ex. 2 | 5 | A | 0.22 |
| Ex. 3 | 7 | A | 0.4 |
| Ex. 4 | 12 | A | 0.4 |
| Ex. 5 | 20 | A | 0.4 |
| Ex. 6 | 10 | A | 0.4 |
| Ex. 7 | 7 | A | 0.4 |
| Ex. 8 | 18 | A | 0.4 |
| Ex. 9 | 14 | A | 0.3 |
| Ex. 10 | 15 | A | 0.45 |
| Comp. | 40 | B | 0.4 |
| Ex. 1 | | | |
| Comp. | 21 | B | 0.22 |
| Ex. 2 | | | |

The following findings were obtained from the results above.

In Comparative Examples 1 and 2, peal stress was high, and jamming occurred due to separation failure.

In comparison to the above, in Examples 1 to 10, peal stress was reduced so that jamming caused by separation failure did not occur.

As a result of the test conducted on various fixing members by the present inventors, it was found that a recording medium could be separated regardless of a type of paper when peel stress of the outermost surface of the rubber (the outermost layer) is 20N/cm² or lower.

Specific reasons have not been known, but it is probably because terminals of molecular chains constituting the outermost surface, which is considered to contribute to give tackiness, are re-crosslinked or re-bonded by the modification treatment performed on the surface of the elastic material.

Accordingly, as a result of the present invention, a fixing member, which can significantly reduce adhesiveness (tackiness) of the outermost surface thereof while maintaining sufficient elasticity to give high image quality corresponding to color image formation, can be realized. By mounting the fixing member of the present invention, moreover, a fixing device and electrophotographic image forming apparatus, which have high reliability and can stably perform fixing over a long period, can be provided.

Embodiments of the present invention are as follows.

<1> A fixing member, containing:

an outermost layer formed of an elastic material,

wherein the fixing member is used in a process for fixing a toner image on a recording medium by heating, and

wherein the outermost layer has peel strength of 20 N/cm² or lower.

<2> The fixing member according to <1>, wherein the outermost layer has universal hardness of lower than 0.5N/mm².
<3> The fixing member according to any of <1> or <2>, wherein the elastic material is rubber.
<4> The fixing member according to <3>, wherein the rubber is rubber having siloxane bonds in a backbone of a molecule thereof.
<5> The fixing member according to <4>, wherein the rubber is fluorosilicone rubber.
<6> The fixing member according to any one of <1> to <5>, wherein the outermost layer is a modified outermost layer.
<7> A method for producing a fixing member, containing:

forming an outermost layer containing an elastic material on a base; and

subjecting the outermost layer to a modification treatment which is a plasma treatment, an electron beam crosslinking treatment, or a UV ozone treatment.

<8> The method for producing a fixing member according to <7>, further containing treating the modified outermost layer with a coupling agent.
<9> A fixing device, containing:

the fixing member as defined in any one of <1> to <6>.

<10> An electrophotographic image forming apparatus, containing:

the fixing device as defined in <9>.

The obtainable effect by the embodiments <1> and <2> of the present invention:

Occurrences of paper jamming caused by transfer paper wrapped around the fixing member can be reduced, and stable fixing operation can be realized over a long period.

The obtainable effect by the embodiments <3> to <6> of the present invention:

In addition to the obtainable effect by the embodiments of <1> and <2>, fixing can be realized with maintaining sufficient elasticity enough to provide high image quality corresponding to color image formation.

The obtainable effect by the embodiments <7> and <8> of the present invention:

The fixing member of <1> to <6> can be provided.

The obtainable effect by the embodiment <9> of the present invention:

In addition to the obtainable effect by the embodiments of <1> to <5>, a fixing device whose reliability is improved can be provided by using the aforementioned fixing member.

The obtainable effect by the embodiment <10> of the present invention:

By using the fixing device, a highly reliable electrophotographic photocopier, facsimile, and laser printer can be provided, which can contribute to “reduction in environmental loads” or “improvement in customer satisfaction.”

This application claims priority to Japanese application No. 2011-135967, filed on Jun. 20, 2011, and incorporated herein by reference.

What is claimed is:

1. A fixing member, comprising:
an outermost layer formed of an elastic material,
wherein the fixing member is used in a process for fixing a toner image on a recording medium by heating, and
wherein the outermost layer has peel strength of 20 N/cm² or lower.

2. The fixing member according to claim 1, wherein the outermost layer has universal hardness of lower than 0.5N/mm².

3. The fixing member according to claim 1, wherein the elastic material is rubber.

4. The fixing member according to claim 3, wherein the rubber is rubber having siloxane bonds in a backbone of a molecule thereof.

5. The fixing member according to claim 4, wherein the rubber is fluorosilicone rubber.

6. The fixing member according to claim 1, wherein the outermost layer is a modified outermost layer.

7. A method for producing a fixing member, comprising;
forming an outermost layer containing an elastic material on a base; and
subjecting the outermost layer to a modification treatment which is a plasma treatment, an electron beam crosslinking treatment, or a UV ozone treatment.

8. The method for producing a fixing member according to claim 7, further comprising treating the modified outermost layer with a coupling agent.

9. A fixing device, comprising:
a fixing member, which contains:
an outermost layer formed of an elastic material,
wherein the fixing member is used in a process for fixing a toner image on a recording medium by heating, and
wherein the outermost layer has peel strength of 20 N/cm² or lower.
